(19) United States
(12) Patent Application Publication
(10) Pub. No.: US 2008/0226095 A1
(43) Pub. Date: Sep. 18, 2008

(54) INTERNET RADIO SYSTEM

(75) Inventors: JEN-HER JENG, Linnei Township (TW); SHIH-CHUNG CHENG, Sinhua Township (TW)

Correspondence Address: ROSENBERG, KLEIN & LEE, 3458 ELLICOTT CENTER DRIVE-SUITE 101, ELLICOTT CITY, MD, 21043, US

(73) Assignee: SIFEON KNOWLEDGE TECHNOLOGY, TAICHUNG CITY (TW)

(21) Appl. No.: 11/686,641

(22) Filed: Mar. 15, 2007

(51) Int. Cl. H04B 3/00

(52) U.S. Cl. 381/81

(57) ABSTRACT

An internet radio system which includes a network connecting unit for coupling to the internet. A storage unit stores a number of addresses of servers in the internet. A graphical user interface can select one of the servers with the network connecting unit links receiving multimedia data from a selected server. A display unit displays the graphical user interface and a processing unit renders the graphical user interface and processes the multimedia data where the processing unit controls the volume of the multimedia data during selection of the servers.

### FIELD OF THE INVENTION

The present invention relates to an Internet radio system, and more particularly to the Internet radio system that fades in or fades out the volume during the station selection.

### BACKGROUND OF THE INVENTION

The Internet has become a cultural fixture as source of both information and entertainment. Presently, various Internet sites offer various audio and video services, for example, there are over one thousand broadcast radio stations that are distributing their content and live, streaming audio signal over the Internet. The distribution of the content of a radio broadcast over the Internet begins by converting the analog, audio signal broadcast by the Internet radio station into a digital format, known as a streaming audio format that is suitable for transmission over the Internet. The streaming audio signal is then provided to a web server that, in turn, distributes the streaming audio signal over the Internet.

Currently, users may listen to these stations over the sound system in their personal computers by using a player software. To use the player software, the user typically accesses the Internet and locates the station to which he or she wants to listen. The user selects the link and the player software launches and buffers the audio stream. However, this process may take up to several minutes, depending upon the system and connection speeds. If an interruption occurs or the user wants to change the program, he or she repeats this process and waits for linking. During this process, the known players do not generate any sound to notify the user.

To overcome the foregoing issues, the inventor of the present invention based on years of experience on related research and development of the data coding technique invents an Internet radio system to overcome the foregoing shortcoming.

### SUMMARY OF THE INVENTION

In view of the foregoing issues, an objective of the present invention is to provide an Internet radio system that provides feedback to the listener during the station selection.

In accordance with the objective of the present invention an Internet radio system includes a network connecting unit, a storage unit and a graphical user interface, a display unit and a processing unit. The network connecting unit is for coupling to the Internet. The storage unit is for storing a plurality of addresses of servers in the Internet. The graphical user interface has at least one button for selecting one of the servers, and the network connecting unit links the selected server based on the address and receives a multimedia data from said selected server. The display unit is for display the graphical user interface. The processing unit is for rendering the graphical user interface and processing the multimedia data. The processing unit fades in or fades out the volume of said multimedia data during selection of said servers.

To achieve the foregoing objective, the Internet radio system operating method of the invention comprises the following steps:
(a) providing a plurality of addresses of radio station servers;
(b) rendering a graphical user interface with a knob GUI element;
(c) displaying said graphical user interface;
(d) using an input unit to turn said knob GUI element;
(e) selecting a corresponding address of radio station server based on the change of said knob GUI element;
(f) linking said selected radio station server;
(g) receiving an audio data from said selected radio station server; and
(h) fading in or fading out the volume of the audio data during the selection process.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

FIG. 1 is a schematic diagram of an Internet radio system according to an embodiment of the present invention; and

FIG. 2 is a flowchart of operating an Internet radio system according to an embodiment of the present invention.

### DETAILED DESCRIPTION OF THE PREFERRED EMBODIMENTS

Refer to the related figures for an Internet radio system according to a preferred embodiment of the present invention, wherein the same elements are described by the same reference numerals.

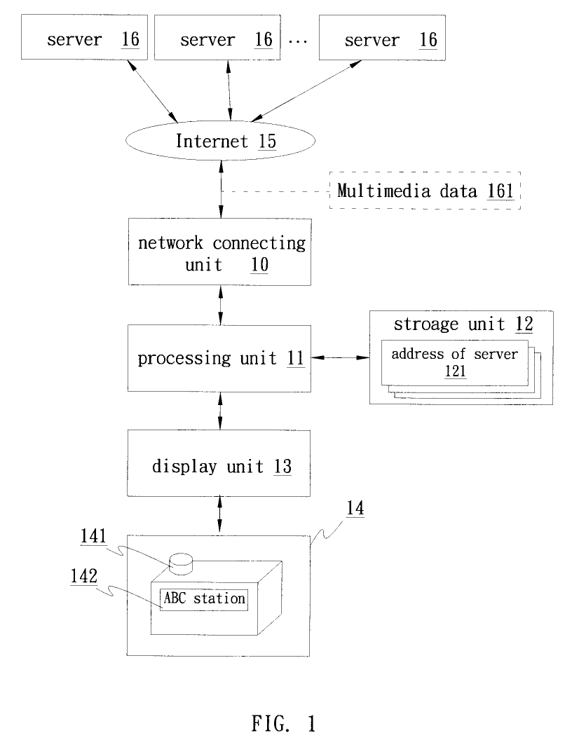

Referring to FIG. 1, a block diagram illustrates an Internet radio system according to an embodiment of the present invention. The Internet radio system includes a network connecting unit 10, a storage unit 12 and a graphical user interface 14, a display unit 13 and a processing unit 11. The network connecting unit 10 is for coupling to the Internet 15. The storage unit 12 is for storing a plurality of addresses of servers 16 in the Internet 15, such as an internet address of a radio station server. The display unit 13 is for display said graphical user interface 14. The processing unit 11 is for rendering the graphical user interface 14 and processing a multimedia data received from the Internet 15. The multimedia data can be, not limitedly, an audio data.

The graphical user interface 14 has at least one button 141 for selecting one of said servers 16. The button 141 can be, not limitedly, a knob GUI element. The listener can use mouse to interactively turn the knob GUI element for station selection that is already known to the listener from normal radios. Based on the angle that the knob GUI element is turned, the processing unit 11 reads the corresponding address of the selected server from the storage unit, and drive the network connecting unit 10 to link the selected server based on the corresponding address and receive a multimedia data from the selected server. Furthermore, the graphical user interface 14 can include a text GUI element 142 for display the information of the selected station.

During selection of said servers, the processing unit may fade in or fade out the volume of the multimedia data. For example, when a listener turns the knob GUI element to change station, the processing unit 11 fades out the volume of the original radio station and fades in the volume of the next radio station when the audio data from the next radio station is ready. This has the advantage that the listener receives feedback if no audio data or only audio data of poor quality are received from the radio station.

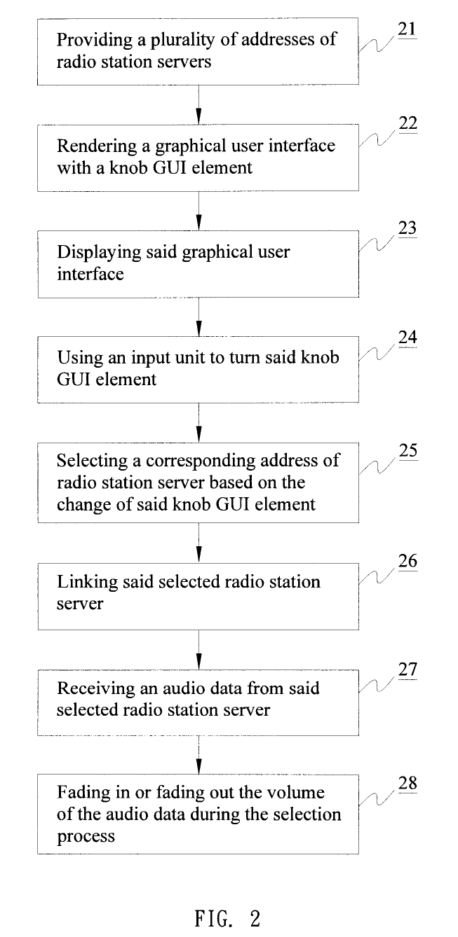

Referring to FIG. 2, a flowchart illustrates an operating procedure in an Internet radio system according to an embodiment of the present invention. In FIG. 2, the operating procedure includes the following steps:

Step 21: providing a plurality of addresses of radio station servers;

Step 22: rendering a graphical user interface with a knob GUI element;

Step 23: displaying said graphical user interface;

Step 24: using an input unit to turn said knob GUI element, the input unit can be a mouse;

Step 25: selecting a corresponding address of radio station server based on the change of said knob GUI element;

Step 26: linking said selected radio station server;

Step 27: receiving an audio data from said selected radio station server;

Step 28: fading in or fading out the volume of the audio data during the selection process.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An Internet radio system, comprising:
a network connecting unit, for coupling to the Internet;
a storage unit, for storing a plurality of addresses of servers in the Internet;
a graphical user interface, having at least one button for selecting one of said servers, and said network connecting unit links said selected server based on said address and receives a multimedia data from said selected server;
a display unit, for display said graphical user interface; and
a processing unit, for rendering said graphical user interface and processing said multimedia data;
wherein said processing unit fades in or fades out the volume of said multimedia data during selection of said servers.

2. The Internet radio system of claim 1, wherein said button is a knob GUI element.

3. The Internet radio system of claim 1, wherein said server is a radio station server.

4. A method for operating an Internet radio system, comprising:
providing a plurality of addresses of radio station servers;
rendering a graphical user interface with a knob GUI element;
displaying said graphical user interface;
using an input unit to turn said knob GUI element;
selecting a corresponding address of radio station server based on the change of said knob GUI element;
linking said selected radio station server;
receiving an audio data from said selected radio station server; and
fading in or fading out the volume of the audio data during the selection process.
